(19) United States
(12) Patent Application Publication
(10) Pub. No.: US 2007/0259781 A1
(43) Pub. Date: Nov. 8, 2007

(54) Chemical formulations for removal of hazardous pollutants from combustion gases

(76) Inventor: Rabindra K. Sinha, McKees Rocks, PA (US)

Correspondence Address: Rabindra K. Sinha, 609 Hancock Court, McKees Rocks, PA, 15136, US

(21) Appl. No.: 11/429,605

(22) Filed: May 8, 2006

(51) Int. Cl. B01J 20/00

(52) U.S. Cl. 502/400

(57) ABSTRACT

Various formulations of chemical compounds are disclosed to help improve the removal of fine particulates and hazardous substances present in combustion gases of fossil and derived fuels. Specifically, the formulation consists of bicarbonate and carbonate of ammonia with or without borates, formates and acetates of sodium and lithium, poly-hydroxy compounds, iodides and sulfides of ammonia and sodium, elemental iodine, elemental sulfur and mixture thereof The formula when injected into a combustion gas stream of a system fitted with an electrostatic precipitator and/or bag house helps remove the fine particulates and hazardous materials present in it.

### BACKGROUND OF THE INVENTION

Fossil fuels such as coal, lignite, peat, oil and derived or prepared fuels such as refuge, industrial wastes or combined fuels contain several impurities that can be hazardous to the environment when they are used for generation of heat, steam or electrical power. The hazardous materials are considered here as those recognized by the US EPA as criteria pollutants and hazardous materials in its several federal register publications over the years (reference).

The non-combustible materials in coal (referring henceforth to all types of coals, lignite, peat and derived or prepared fuels) commonly known as ash constitute the largest fraction of the impurities. Depending on its source (global), it can constitute up to 60% of its total weight. Upon combustion, the ash becomes entrained in the gas, together with other impurities, and leaves the stack. The entrained ash is commonly known as fly ash. For environmental reasons, particulate control devices are installed to remove a significant portion of this fly ash, before the flue gas leaves the stack. The most common among the particulate control devices is known as Electrostatic Precipitator (ESP) and it can be used in combination with other particulate control devices such as bag houses, cyclones, wet and dry scrubbers, etc.

As mentioned in the preceding paragraph, the most common particulate removal device employed by the largest coal boiler operators is an ESP. The use of ESP for particulate removal, separation and sometimes beneficiation of valuable materials have been in vogue since its discovery in the early 1900s. The design and operating principles of ESP is easily available in technical literatures. U. S. Pat. Nos. 5,029,535 and 5,122,162 (to Krigimont, et al.) disclose a precipitator. Electrostatic precipitation, by Oglesby and Nichols, Marcel Dekker, Inc., New York 1978, and “Industrial Electrostatic Precipitation” by Harry J. White, International Society for Electrostatic Precipitation, 1962 provide a good background on the subject. See also U. S. Pat. No. 3,523,407 to Humberg, and the Journal of the Air Pollution Control association, Volume 18, “Experience with Electrostatic Fly-Ash Collection Equipment Serving Steam-Electric Generating Plants”, pp. 523-528, Reese and Greco, August 1968.

The particulate (or ash) collection efficiency of an ESP depends on a combination of factors, most common among them are fuel ash content, its chemical make-up, gas temperature, ESP design, etc. The ash content and its chemical make-up vary widely from one coal to another and in the same coal from one location to another. The coal heterogeneity presents a challenge in effectively cleaning the flue gas. In addition, methods of fuel firing or combustion affects the properties of the ash generated which have a strong influence on its collectivity in particulate control devices such as an ESP. These factors make it very difficult for operators of combustion devices to meet the regulatory constraints on particulate emissions.

Technical and commercial attempts have been made since late 1960s to utilize various chemicals and proprietary formulations to minimize the effects of coal heterogeneity and combustion variability. Sulfur trioxide and the moisture content of flue gas were recognized as important criteria influencing the performance of ESP and its design. Use of sulfur trioxide and moisture, either independently or individually became a commercial method of improving the performance of ESP. Both of these components, sulfur trioxide and moisture in the form of water vapor in the flue gas were shown to gainfully affect the electrical resistivity of the fly ash. They in conjunction with each other and sulfur trioxide in the presence of added ammonia are believed to increase the agglomerating properties of the exposed fly ash.

Use of sulfur trioxide became much more acceptable in the industry. Use of systems consisting of sulfur burner to produce sulfur dioxide followed by catalytic oxidation of sulfur dioxide to sulfur trioxide at coal fired boiler sites became quite successful for many coal fired systems. Unfortunately, despite many sophisticated controls and performance predictive theories and practices, this system is not universally applicable to all coals and all systems. For example, the sulfur trioxide conditioning does not work well or requires a heavy treatment rate on high calcium western coals. This conditioning also does not work in systems where the flue gas temperature exceeds about 300° F. In addition, the capital costs involved with sulfur trioxide conditioning systems are disadvantageously high. Further, in many a situation, the added sulfur trioxide causes acid corrosion to the ESP box and its attendant equipment.

McKewen disclosed use of ammonium sulfate, either as a powder or an aqueous solution through U. S. Pat. No. 3, 665, 676 issued in 1972. He suggested using it at temperatures between 400° F. and 800° F. and recommended adding it after the air pre-heater in cold side applications. Unfortunately, it did not work well because the requisite levels of SO₃ could not be produced from thermal decomposition at temperatures prevailing in cold side ESP.

Bennet et al. disclosed the use of dry ammonium sulfate through U.S. Pat. Nos. 4,042,348 and 4,043,768. To be effective, ammonium sulfate had to be used at temperatures above 1000° F. This meant that it had to be added at locations prior to the air pre-heater in the coal fired boiler systems. Indiscriminate use of ammonium sulfate as a conditioning agent for improving the performance of ESP resulted in air pre-heater basket pluggage requiring costly, un-scheduled outages for cleaning.

Slowly, the understanding from the use of ammonium sulfate, ammonium bisulfate, and sulfamic acid as conditioning agents evolved that both ammonia and sulfic acid can be simultaneously utilized to do a better job of conditioning (Dismukes, Edward B. “Conditioning of Fly Ash with Sulfamic Acid, Ammonium Sulfate, and Ammonium Bisulfate”, Environmental Protection Technology Series, EPA-650/2-74-114 (1974)). This became more apparent for Eastern Bituminous coal burning and in furnace operations where high levels of unburned carbon remained in the fly ash. Unfortunately, this also is not a universal solution. In addition, it not only required the expensive equipment for SO₃ production through sulfur burner and catalytic system but also required on-site installation and handling of ammonia, a hazardous substance.

Use of ammonia gas alone (Dismukes, Edward B. “Conditioning of Fly Ash with Ammonia”, JAPCA, February, 1978, pp 152-156) was tried and found to be successful in many cases of coal firing. Its use as a conditioning agent in the recovery of petroleum cracking catalyst became quite successful at temperatures around 500° to 600° F.

But as Dismukes and other workers pointed out, use of pure ammonia in coal firing caused unacceptable clogging of air pre-heater baskets in hot side ESP applications and formation of white plumes in cold side ESP. In addition, high levels of moisture, more than 10% (Harry J. White, International Society for Electrostatic Precipitation, 1962, pp 311), is required to lower the electrical resistivity of some high resistivity ashes.

Sinha discloses (U. S. Pat. No. 6,001,152) the use of certain ammonium compounds such as ammonium nitrate in combination with other nitrates to control particulates and other pollutants. He contends that the formulation helps to improve the agglomeration of the treated fly ash. Some of the nitrate compounds mentioned in his patent are hygroscopic and so the enhanced agglomeration of the treated ash can result from that. In addition, some nitrate mixtures form lower melting eutectic and agglomeration may result from that as well. He also suggests incorporation of poly hydroxy compound to further aid the agglomeration process.

Use of ammonia in flue gas for NOx control (by Exxon De-NOX process and Selective Catalytic Reduction (SCR)) has become more common. Since a large quantity of ammonia (about 1 pound of ammonia for every 3 pounds of NO) is required, on-site production by the hydrolysis of urea is employed. Claims have been made that by proper controls and adjustments, the level of injected ammonia can be kept above that is required for the SCR catalyst to help improve the performance of ESP for a better particulate collection. These attempts have not been successful in actual practice for it has caused pluggage of the SCR catalyst and also of the air pre-heater baskets.

It is desirable, therefore, to find a method that helps improve the collection efficiency of ESP for particulates. It will also be desirable to find a method that also helps the removal of other toxic and hazardous substances present in a gas stream, particularly that of a flue gas of coal fired system.

### BRIEF SUMMARY OF THE INVENTION

Various work in the art of flue gas conditioning (enhancement of particulate removal by particulate control devices), whether it is by traditional, such as S—SO₂—SO₃ and/or NH₃, or untraditional (other chemical formulations), methods show limitations. In the case of traditional methods, particularly when using S—SO₂—SO₃ method, is limited to temperatures below 300° F. It is also not very suitable for Western Coals, particularly the Powder River Basin Coal, which is considered the bell weather of low sulfur coals in the USA. Use of ammonia by itself shows no improvement of surface resistivity, an important mechanism by which flue gas conditioners work on highly resistive ash or is a chemical that is hazardous to store, handle and use on-site and requires Toxic Release Inventory Permitting by the local, state and federal agencies.

The non-traditional methods, such as mixtures of sodium, ammonium, and lithium sulfates, nitrates, chlorides, phosphates, various amines, sulfuric acid, phosphoric acid, etc., are either less effective than the traditional conditioners or are water based causing deposits of ash in the duct work. Heavy ash deposits require frequent physical cleaning costing special equipment and plant/unit downtimes.

The invention, as disclosed here, overcomes the limitations of the traditional and non-traditional methods of flue gas conditioning. It also helps remove other toxic materials such as mercury, sulfic acid, etc., by capturing them together with the ash particulates. Use of the invented composition, when presented as powder, eliminates any ash deposits in the duct that is most prevalent when using aqueous solutions. The invented powder composition can also be used to remove other hazardous materials than fine particulates.

### DETAILED DESCRIPTION OF THE INVENTION

Compositions of the invention comprise one or more ammonium compounds, with or without nitrates of other cations than ammonium, iodide compounds, and organo-poly hydroxy compound. Ammonium compounds utilized in this invention are bicarbonate, carbonate (a mixture of ammonium carbamate and bicarbonate), sulfate and nitrate. The nitrates utilized are sodium and lithium nitrates and nitric acid, although other nitrates can also be used. The organo-poly hydroxy compound used is sugar, a disaccharide. Other poly hydroxy compounds may also be used.

The invention compositions are believed, although not restricted to it, to enhance the performance of electrostatic precipitators by lowering the electrical resistivity of the gas entrained particulate materials and by increasing their cohesivity. Lowering the resistivity improves the initial collection efficiency of the precipitators, and increasing the cohesivity promotes the subsequent retention of the collected particulates.

It is also believed, although not restricted to it, that the compositions of the invention lower the high and low temperature resistivity of particulates by raising their sodium and/or lithium levels and by increasing the amount of sulfur trioxide by oxidation of the naturally present sulfur dioxide in the flue gas stream. The invention compositions may also improve the cohesivity of particulates by enhancing their moisture-retention capacities and by forming a molten composition on the surface of the particulate material. It is believed, again not limited to this belief, that all of these factors combine together to maximize ESP performance. There may also be other less-understood secondary factors by which the compositions of the invention enhance the performance of the ESP.

The invention compositions also facilitate the removal of hazardous substances. Hazardous substances often appear in the flue gas stream as gas, aerosols, liquid droplets, fumes, solids, or become attached to entrained particulate materials. The ESP removes a portion of the non-gaseous materials together with the ash particulates. Enhancement in performance by invention formulations leads to better removal of hazardous materials through the collected particulates in the ESP. In addition to removal by enhancement of ESP performance, the invention also enhances the entrapment of the hazardous materials by the ash.

The entrapment is facilitated by both physical and chemical means. In the case of mercury, it is believed which is not limited to it, that it forms sulfides and iodides and/or absorbs in the molten droplets of the invention. Chemical and physical means of enhanced entrapments of hazardous materials also leads to removal by any particulate control device such as bag houses or a combination of ESP, bag house and cyclones. However, there may be other mechanisms operative by which removal of hazardous materials by the invention compositions are also facilitated.

For the formulation to be effective, it must be injected into the flue gas at a location prior to particulate control devices. The invention formulations or compositions can be injected in the gas stream as dry or water based liquid. In the dry form it can be injected or blown in as fine powder either alone or mixed with inert diluents such as silica, alumina, various clays, talc, vermiculite, fly ash, etc. Mixing the dry formulation with any of the diluents or mixture of diluents, again as fine powder, is recommended for ease of proper metering and to ensure a good dispersion of the invention in the gas stream. Diluents can also help the ease of handling the powder.

The invented compositions in their powder forms improvise hugely on products of prevalent commerce. Most products of commerce today for this purpose, also known as flue gas or fly ash conditioners, are water-based liquids. Some examples of such products are ARKAY Tech ATI-2001, ADA-ES ADA-23, ADA-37, ADA-46, etc. Although the liquid products of commerce are effective in helping ESP and bag houses to some degree they suffer from one major draw back. They all cause deposits of ash in the duct work requiring cleaning and removal on a periodic basis.

Although several attempts have been made to minimize ash deposit formation by improving the atomizing nozzles used to apply the product, or the technique of atomizing by better and proper control of atomizing air flow, its pressure etc., or by using steam for rapid vaporization of the conditioning agent, no fool proof method has yet been found. The lack of an application technology that eliminates the ash deposit formation has limited the use of such products to duct work where significant space exits for proper atomization/vaporization. This requirement is seldom available in older boilers burning Eastern coals.

To overcome this major draw back an effective dry product for improving the performance of ESP and bag houses is required. The current invention fulfills this need.

Even though the formulation is developed for use as a dry powder but as the components of the disclosed formula are water soluble, a convenient means of applying the formulations can also be as an aqueous solution. In the aqueous form the solution can be injected as fine mists where appropriate. Compressed air or steam can be conveniently employed to inject the aqueous form of the formula into the flue gas stream. Additional water may conveniently be employed to dilute the neat formulation to help improve the quality of dispersion in the gas stream.

The main intent has been to develop a formulation that can be injected in the flue gas stream in a dry form. It is believed that only the dry powder form of a composition that is effective as a Flue Gas Conditioning (FGC) agent can overcome the problems of ash deposition on the gas ducts and its internals. Many types of formulations based on known agglomerating and imparting electrical conductivity were conceived and prepared in the dry form in the lab. They all, except for a few disclosed in here, had a very little chance of overcoming the logistics and the special care required to be of any practical value in actual field applications.

Some of the prepared compositions in the dry form were tested for their effectiveness for particulate control in an actual operating system and compared with those commercially available. They were also tested for the simultaneous removal of particulates and mercury from flue gases.

The following formulations were prepared. Initially they were tested in the laboratory to ascertain their effects on the electrical and agglomerating properties of the treated ash as these properties are thought important for particulate collection by ESP and bag houses. The promising formulations were tested in the field on operating boilers fitted with electrostatic precipitators.
Preparation I: ATI-2001 (available as a proprietary, patented product from ARKAY Technologies, Inc., 609 Hancock Court, McKees Rocks, Pa. 15136), dried and ground to a powder.
Preparation II: A dry formula prepared according to a composition disclosed by Sinha in U.S. Pat. No. 6,001,152.
Preparation III: A dry formula prepared according to a composition disclosed by Sinha in U.S. Pat. No. 6,001,152 but mixed with alumina powder in 50/50 proportion.
Preparation IV: A proprietary Formulation, which for the sake of simplicity for this disclosure will be known as “Formula A”, from ARKAY Technologies, Inc.—A Liquid.
Preparation V: Ammonium Bi-Carbonate (ABC), powder (available from Church & Dwight, Princeton, N.J.), untreated and treated, 90% by weight and sodium tetra borate penta hydrate(STBP), powder (available from US Borax, Valencia, Calif.), 10% by weight. Preparation VI: ABC-—60%, STBP—10%, Talc (available from Luzenac America, Centennial, Colo.)—30%; all by weight.
Preparation VII: ABC—60%, Sodium Formate (from Perstorp Polyol, Toledo, Ohio)—20%, STBP—5%, and Talc—15%; all by weight.
Preparation VIII: ABC—60%, Sodium Formate—20%, STBP—5%, Talc—10%, Sugar—5%; all by weight.
Preparation IX: ABC (treated) powder—100%.
Preparation X: ABC (treated) powder—95%, Sugar—4.5%, Sodium Iodide—0.5%.

Two sources of Fly Ash were selected for conducting some of the laboratory tests. One was from burning low sulfur (˜1% wt.) Eastern Coal in a 570 MW generating Eastern Utility Boiler and another from Burning a Western (Powder River Basin) Coal in a 350 MW Mid Western Utility Boiler. Both groups of ashes were sieved through a 100 mesh US Screen sieve and −100 mesh ash material from each source was utilized for tests conducted below.

As mentioned before, several dozens of preparations were made and their physical properties, weight loss characteristics at room and higher temperatures, etc., were studies but the results on the above preparations are discussed here, as they are relevant to demonstrate the uniqueness of the invention.

### EXPERIMENT I

20 grams of all the above preparations, except number IV were individually sealed in a plastic bag. Although preparations I-III that were dry and free flowing powders initially to begin with started to become agglomerated and paste, liquid-like over a period of several weeks of storage at room temperature. The other five formulations remained dry and relatively free flowing for months when this study was terminated.

### EXPERIMENT II

48.75 grams of Eastern and 48.75 grams of Western Fly Ash was mixed separately with 1.25 grams of the above formula, except when using Formula IV, it was first diluted with water to yield a paste like material when mixed with each ash. All ash-preparation mixtures were individually kept in sealed plastic bags, except in the case with preparation IV in which case the paste like ash was first dried in an oven maintained at 100° C., followed by crushing and sieving through 100 mesh screen. Thus each fly ash mixed with any formulation contained 2.5% (by wt) of the treatment formulation in it. The following observations were noted:

Eastern Ash: All samples looked agglomerated, non-dusty and produced small spherical balls when swirled in a pan. Formation of spherical balls is a sign and indication of treatment imparting special agglomerating properties to the fly ash. The level of agglomeration brought about by any of the above nine formulations were quite similar and considered excellent. The untreated ash is non-agglomerated and very dusty.

Western (PRB) Ash: Again all formulations imparted good agglomeration and made the ash much less dusty than the untreated ash. The treated ash formed small spherical balls upon swirling in a pan. The treated ash acquired a slight odor of ammonia that went away with time or upon slight heating.

### EXPERIMENT III

Some of the treated samples of the ash were submitted for their electrical resistivity tests together with their corresponding untreated (or Blank) ash. The tests were conducted by reputed outside labs that are known for performing special tests as a part of their business. The test is developed by the Institute of Electrical Engineering and is designated as IEEE Standard 548-1984.

The electrical resistivity of fly ash is a very important -criterion in developing and designing an ESP. Ash having an electrical resistivity between 1×10⁷ to 2×10¹⁰ is considered appropriate for easy collection in the ESP. A good collection is required to meet the regulatory requirement on particulate emission from an ESP. Ashes having their resistivities beyond this range are either too difficult or too easy to collect. Ashes with resistivities above 2×10¹⁰ are considered difficult to collect. This difficulty, in addition to poor collection efficiency of the ESP is also noted from such ashes to cause heavy frequencies of sparking and low electrical power in the ESP box.

When the electrical resistivities are below 1×10⁷, the ash collects on the plate very well but is re-entrained easily and quickly too causing unacceptable levels of emissions and opacity spikes.

The resistivities test results are shown in Tables 1 and 2. Table 1 presents data for the Eastern Coal Ash determined at around 300° F. in presence of 8-10% moisture containing air at an electrical field strength of 4 KV/cm . The untreated or “blank” ash in this table shows unacceptably high resistivity of 8×10¹¹. The blank ash is therefore a difficult to collect ash in the ESP, a fact well proven, known and experienced by the utilities from where this ash was collected. The same holds true for the Western Ash as presented in Table 2.

TABLE 1
The effect of treatment on the electrical resistivity
of a Eastern Coal Ash at ˜300° F.

| TREATMENT TYPE | RESISTIVITY (ohm-cm) |
|---|---|
| None (Blank) | 8 × 10¹¹ |
| Formula I | 4 × 10⁹ |
| Formula II | 3 × 107 |
| Formula III | 1.5 × 109 |
| Formula IV | ND |
| Formula V | 2 × 10¹⁰ |
| Formula VI | 4 × 10¹¹ |
| Formula VII | 8 × 10⁹ |
| Formula VIII | 1 × 10¹⁰ |
| Formula IX | 2 × 10¹¹ |
| Formula X | 2 × 10¹¹ |

ND = Not Determined

TABLE 2
The effect of treatment on the electrical resistivity
of a Western Coal Ash at ˜300° F.

| TREATMENT TYPE | RESISTIVITY (ohm-cm) |
|---|---|
| None (Blank) | 1.5 × 10¹¹ |
| Formula I | 3 × 10⁸ |
| Formula II | 1.0 × 10⁸ |
| Formula III | 1 × 10⁹ |
| Formula IV | ND |
| Formula V | 6 × 10¹⁰ |
| Formula VI | 1 × 10¹¹ |
| Formula VII | 1 × 10¹⁰ |
| Formula VIII | 3 × 10¹⁰ |
| Formula IX | 8 × 10¹⁰ |
| Formula X | 9 × 10¹⁰ |

The effect of lowering the ash resistivity by treatment with the disclosed formulations means that the treatment made the ash more acceptable for collection in the ESP. This process of making ash more conducive to collect is known in the industry as Flue Gas Conditioning. The effect of a successful conditioner is improved collection, less emissions and lower opacities in actual operating systems.

The results on resistivity presented in the above two tables clearly indicate that the preparations are effective in lowering the resistivity of the treated ash. The advantages of preparations V-X are that they are in the powder form and can remain a powder for a long time.

The preparations number IV and VIII were selected to conduct a test in an actually operating utility boiler burning PRB coal. The utility selected was a mid-western operation generating about 360 MW. The unit utilizes ARKAY ATI-2001 as their flue gas conditioner to keep the stack opacity around 15% on a regular basis. Maintaining a six-minute average opacity of 15% on a regular basis with an intermittent feed of ATI-2001 is significantly lower than their compliance requirement of 20%. The plant operators maintain that ATI-2001 is one of the most effective flue gas conditioners they have used.

An eductor fabricated by Tyco Valve Controls of Prophetstown, Ill. and sold by Penberthy Jet Pumps was utilized to inject the powder formulation into one of the gas ducts. The results of the injection on the ESP power levels and the stack opacity were compared with the other duct in which the ARKAY ATI-2001 was injected. A special lance fabricated to inject and distribute the powder was fabricated and utilized for this test.

The unit operators have had a long (over fifteen years) experience with Flue Gas Conditioners supplied by different vendors. They know that when the flue gas conditioning compound from a given vendor is ineffective, then they see an immediate drop in ESP power level, increase in sparking rates and increase in instantaneous and six-minute average stack opacities. The opposite is true with an effective Flue Gas Conditioner is used instead, that is, the ESP power levels increase, and the sparking rates and the opacities decrease. The test results on opacities, ESP Power levels and sparking levels with the selected formulations, that is, Formulation IV, V, and VII are compared with the standard flue gas conditioner, ATI-2001, in Table 3.

TABLE 3
Effects of Treatment on Opacities, Power Levels and Spark Rates

| | | | Secondary | |
|---|---|---|---|---|
| | Stack | Cumulative | Power, KW | |
| Treatment | Opacity, | Spark Rate, | (Treated | Gross Unit |
| Product* | % | min⁻¹ | Duct) | Load, MW |
| ATI-2001 | 12 to 15 | 72 to 75 | 65 to 75 | 353 to 358 |
| Formula IV | 9 to 12 | 31 to 55 | 75 to 90 | 353 to 358 |
| Formula VI | 11 to 15 | 65 to 75 | 65 to 80 | 353 to 358 |
| Formula VII | 11 to 15 | 68 to 75 | 65 to 75 | 353 to 358 |

*Note:
ATI-2001 and the Proprietary formula, Formula IV, were fed in all gas ducts whereas formulae VI and VII were fed in only one duct.

It is apparent from Table 3 that Formula IV was more effective than the standard flue gas conditioner ATI-2001 as treatment with it increased the ESP power levels and decreased the spark rates and the stack opacity. It should be noted that Formula IV and ATI-2001 were fed to all the gas ducts. Thus their effects were cumulative. The results with Formula VI and VII were also beneficial to the ESP. Treatment with these formulations maintained similar electrical effects, that is, the spark rates and the secondary powers remained similar to the results when treated with ATI-2001. Since ATI-2001 is the standard flue gas conditioner, the formulations prepared with the chemistries chosen for Formula VI and VII were also effective.

Based on the various laboratories and the actual field tests I have demonstrated that the formulations based on disclosed chemistries and their blends are effective flue gas conditioners and can be used either in dry powder form or aqueous solutions.

I thus claim::

1: A formulation consisting of ammonium bicarbonate and ammonium carbonate with or without sodium borate, sodium formate, sodium and ammonium iodides, sodium and ammonium sulfides, sulfur, iodine, poly hydroxy compounds, and mixtures thereof for the removal of fly ash particulates and other pollutants from a combustion gas stream at temperatures above 200° F.

2: A formulation according to claim 1 above that is a dry powder.

3: A formulation according to claim 1 above that is an aqueous solution.
